(19) United States
(12) Patent Application Publication
(10) Pub. No.: US 2014/0225947 A1
(43) Pub. Date: Aug. 14, 2014

(54) POSITIVE IMAGE TRANSFER THERMAL PRINTER FOR ARTICLES SUCH AS HISTOLOGICAL SPECIMEN SLIDES AND CASSETTES

(71) Applicant: PRIMERA TECHNOLOGY, INC., Minneapolis, MN (US)

(72) Inventors: Robert P. Cummins, Deephaven, MN (US); Darren W. Haas, Minnetonka, MN (US)

(73) Assignee: PRIMERA TECHNOLOGY, INC., Minneapolis, MN (US)

(21) Appl. No.: 13/764,461

(22) Filed: Feb. 11, 2013

(51) Int. Cl. B41J 2/21

(52) U.S. Cl. CPC B41J 2/21
USPC 347/9

(57) ABSTRACT

A printer for printing information onto articles such as histology specimen slides and cassettes having a print zone. One embodiment of the printer includes an ink receiving structure to receive an ink source such as a print ribbon, a collection receiving structure to receive a collection medium such as paper or polymer web, a printing area including a printhead, a rubber-like laminator, and a control system. The control system is responsive to print data and causes the printhead to transfer a first color and first format image, such as a negative image, away from the ink source and onto the collection medium to form a first color and second format image, such as a positive image, on the ink source, and causes the laminator to transfer the second format image from the ink source to the print zones of the articles.

### BACKGROUND

The present invention relates to monochrome and color printers and related devices and methods for articles including but not limited to histological specimen containers such as slides and cassettes.

Printers for printing information such as text, indentifying color bars and bar codes on containers such as slides and cassettes used to process histological specimens (e.g., tissue biopsies) are generally known and commercially available. Color printers of these types, as well as slides and cassettes that can be used with the printers, are disclosed, for example, in PCT International Application Publication Nos. WO 2012/036865, WO 2012/036866, WO 2012/036867 and WO 2012/036874, and the Ohshima U.S. Pat. No. 6,228,805 and the Haas U.S. Pat. No. 6,261,012, all of which are incorporated herein by reference for all purposes.

There remains a continuing need for improved printers and related devices and methods for articles such as histological sample containers. In particular, there is a need for printers and methods that are efficient to operate, and that enable information to be accurately and durably printed on the articles.

### SUMMARY

A printer for printing information onto articles such as histology specimen slides and cassettes having a print zone. One embodiment of the invention includes an ink receiving structure to receive an ink source such as a print ribbon, a collection receiving structure to receive a collection medium such as paper or polymer web, a printing area including a printhead, a laminator, and a control system. The control system is responsive to print data and causes the printhead to transfer a first color and first format image, such as a negative image, away from the ink source and onto the collection medium to form a first color and second format image, such as a positive image, on the ink source, and causes the laminator to transfer the second format image from the ink source to the print zones of the articles.

In another embodiment the ink receiving structure receives a multi-colored ink source. The control system causes the printhead to transfer second and optionally additional color first format images away from the ink source and onto the collection medium to form second color and optionally additional color second format images on the ink source, and causes the laminator to transfer the second and optionally additional color second format images from the ink source to the print zones of the articles. The laminator is a rubber-like roller in embodiments of the invention.

### BRIEF DESCRIPTION OF THE DRAWINGS

FIG. 1. is a diagrammatic illustration of a positive image transfer thermal cassette printer in accordance with one embodiment of the present invention.

FIG. 2 is an illustration of a portion of a color print ribbon that can be used with the printer shown in FIG. 1, with portions of the print ribbon printed with specimen information.

FIG. 3 is a diagrammatic illustration of a positive image transfer thermal cassette printer in accordance with another embodiment of the present invention.

FIG. 4 is a diagrammatic illustration of a positive image transfer thermal slide printer in accordance with yet another embodiment of the present invention.

FIG. 5 is a diagrammatic illustration of a cassette with a print zone being conditioned by a print zone conditioner in accordance with another embodiment of the invention.

### DETAILED DESCRIPTION

Embodiments of the invention described herein are color and monochrome printers using thermal transfer printing technologies to provide printed specimen information on histological specimen containers such as slides and cassettes of the type described in the above-identified PCT publications and patents. The specimen information printed using printers and methods in accordance with the invention can include text, identifying color bars, bar codes and other information of the types described in the above-identified PCT publications. As described in greater detail below, embodiments of the invention use what can be referred to as a positive image transfer process. The printer and method can also be used to print on other articles. Embodiments of related devices and methods such as print zone conditioning are also described.

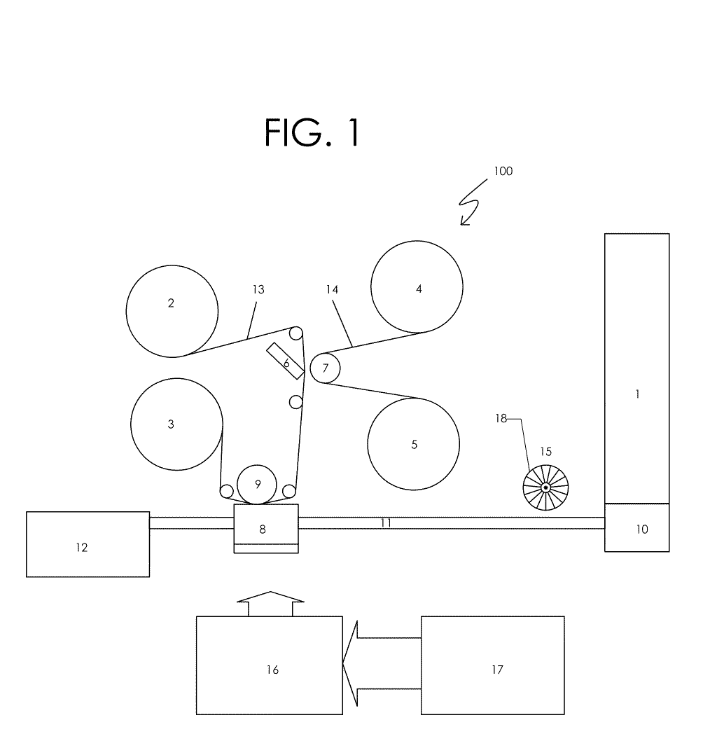

FIG. 1 is an illustration of a histological cassette printer 100 in accordance with one embodiment of the invention. The operation of the printer 100 is controlled by controller 16 that is coupled to the electrical components of the printer. Tissue cassettes (not shown) to be printed by the printer 100 can be loaded in an input station or area 1. The cassettes are removed from the input area 1 by an in-feed mechanism 10 and in the illustrated embodiment are positioned on a shuttle 8. Transport mechanism 11 drives the shuttle 8 and cassette thereon with respect to a print area conditioner 15 to a lamination station or area including a laminator such as lamination roller 9. As described in greater detail below, the print area or zone on the cassette is conditioned or scuffed by the print area conditioner 15 to enhance the durability of the ink bond to the cassette. The negatives of monochromatic or color images containing specimen information are printed away from portions of a print ribbon 13 to a negative image collection media 14 by printhead 6 at the print station or area. Positive images of the specimen information remain on the print ribbon 13 following the printing operation. At the lamination area the portions of the print ribbon 13 with the remaining positive printed specimen information image are laminated onto (i.e., are applied or transferred to) the print zone of the cassette. The printed cassette is then driven to the output station or area 12 by the transport mechanism 11. In other embodiments of the invention (not shown), cassettes are transported from the input area 1 to the output area 12 by other mechanisms (e.g., rollers).

Embodiments of printer 100 configured to print in color can use a multi-color thermal transfer print ribbon 13 that can be provided on supply 2, and a negative image collection media 14 that is, for example, provided as an elongated web on supply 4 in the illustrated embodiment. Following use, the print ribbon 13 is collected on take-up 3 and the negative image collection media 14 is collected on take-up 5. The print media and negative image collection media can take different forms, and can be supplied and collected by different mechanisms, in other embodiments of the invention (not shown).

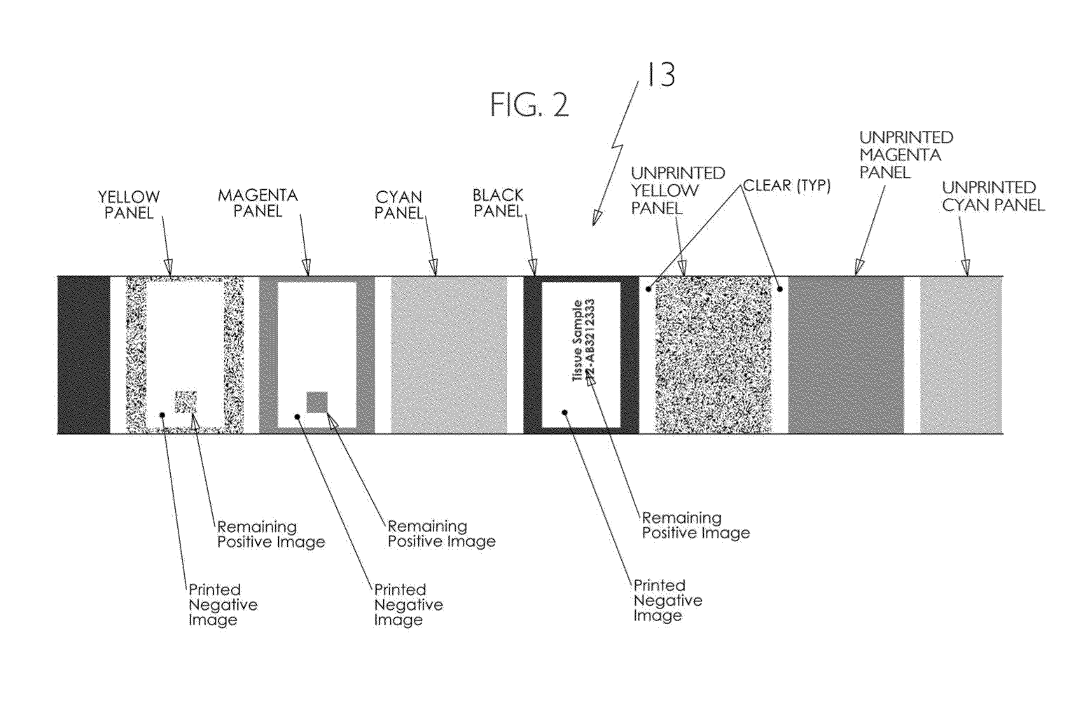

An embodiment of print ribbon 13 (i.e., the print media) that can be used for color printing is illustrated in FIG. 2. Print ribbon 13 includes a polymer substrate carrying a heat transferrable ink layer. In the illustrated embodiment the ink layer includes blocks or panels of ink of different (typically primary) colors (e.g., yellow, magenta, cyan and black in one embodiment) spaced in a repeating pattern along the length of the ribbon 13. In other embodiments, such as those configured to print in monochrome, the ink layer can include a single color ink (e.g., black ink) and need not be in blocks. The ink can, for example, include heat-transferrable resins or waxes. Collection media 14 can be any material such as paper or polymer film that accepts the ink during the printing operations using printhead 6 as described below.

Controller 16 is coupled to receive print jobs from a device such as computer 17. The print jobs include data relating to the desired specimen information and images to be printed. Controller 16 processes the data and controls the printer 100, including printhead 6, in a manner that causes the specimen information images (e.g., including text characters and barcodes) to be effectively printed in the desired form and color(s) onto the print ribbon 13 (i.e., the negative images are printed off of the print ribbon and onto the collection media). During a first color print cycle, with the printhead 6 at a spaced-apart position (e.g., raised by a printhead raising and lowering mechanism) with respect to the print platen roller 7, controller 16 advances and registers a leading edge of an unused portion of the collection media 14 at the printhead between the printhead and print platen roller. Registration marks can be located on the collection media 14 to designate areas or regions on the collection media. Controller 16 also advances the print ribbon 13 to position and register a leading edge of a first ink panel of the desired color at the printhead 6. The printhead 6 and print platen roller 7 are then brought together (e.g., the printhead is lowered) to position the ink layer of the print ribbon 13 next to and typically in contact with the collection media 14. The co-located portions of the print ribbon 13 and collection media 14 are then driven together (i.e., simultaneously) in a first or print direction past the printhead 6. During this printing operation the printhead 6 is actuated to print away from the print ribbon 13, and onto the collection media 14, a negative of the image (i.e., a first format image) of the specimen information desired to be printed onto the cassette. Remaining on the print ribbon 13 is the positive of the image (i.e., a second or opposite format image) of the specimen information desired to be printed onto the cassette print zone.

After printing (i.e., printing away) the first color image portion of the specimen information from the first color panel on the print ribbon 13, the printhead 6 is raised or otherwise moved to a spaced-apart position with respect to the print platen roller 7 and a lamination cycle or operation is performed at the lamination area. During a lamination cycle, with the laminator roller 9 raised or otherwise spaced-apart from the cassette print zone, the print ribbon 13 is driven to advance the printed image area to the lamination area and to register the printed area with the print zone on the cassette. The laminator roller 9 is then lowered or the laminator roller and shuttle 8 or cassette are otherwise moved together to place the printed area of the print ribbon 13 into contact with the cassette. The cassette and print ribbon 13 are then driven together (i.e., simultaneously) through the lamination area with the print ribbon between the hot laminator roller 9 and cassette print zone. Heat and/or pressure applied by this lamination process causes the printed image portion of the ink on the print ribbon 13 to transfer onto and to adhere to the print zone of the cassette.

In embodiments of the invention, the laminator roller 9 is formed from rubber-like or similar material that is compliant and/or elastic, or has such a rubber-like or other similar material coating or surface. During the lamination process the laminator roller 9 deforms, and will conform to the overall surface shape (e.g., uneven or curved or other general unevenness), as well as to any surface roughness such as peaks and valleys or depressions, and around other imperfections (e.g., from dust and debris) produced by the molding process typically used to form the cassette and print zone surface. Heat and pressure is thereby applied relatively consistently across the surface of the cassette print zone. Unlike other printing technologies that make use of a rigid printhead to print directly onto the object being printed, the surface of the specimen container being printed in accordance with embodiments of the invention need not be flat because the laminator roller 9 can deform to accommodate and follow the variations in surface flatness. The printed information is thereby applied consistently and continuously, without gaps, across the print zone surface. Another advantage of printer 100 is that it enables printing all the way to the edges of the cassette or other container. In this illustrated embodiment of the invention, the printing and laminating cycles includes sequential printing and laminating operations.

Additional print and lamination cycles are performed if the image of the specimen information to be printed requires multiple ink colors. In one embodiment of the invention the print ribbon 13 is driven in a second or opposite direction or to otherwise position the leading edge of a second color ink panel adjacent the printhead 6. Print and lamination cycles such as those described above are then performed to print the second color image portion onto the print ribbon 13, and to laminate the second color printed ink panel onto the cassette print zone. Print and lamination cycles can be repeated for any third or fourth colors of ink needed to print the desired specimen information image before the cassette is transferred to the output area. FIG. 2, for example, shows remaining positive images on yellow, magenta and black ink panels that can be used to print specimen information including a red color block and black text onto a cassette. The portions of print ribbon 13 and collection media 14 remaining following printing operations are waste product that can be disposed of. As shown in FIG. 2, the outside of the printed negative block can be larger than the print zone on the cassette so only the specimen information image is transferred to the cassette.

In another embodiment of the invention, color printing is done by first sequentially printing each of the ink panels on the print ribbon 13 in a manner similar to that described above, and sequentially laminating the printed ink panels onto the cassette print zone in a manner similar to that described above after all the ink panels are printed. Overall printing throughput speed can be enhanced by this sequence of print and lamination cycles. Still other embodiments of the invention can use other sequences of print and lamination cycles.

Tissue cassettes produced by molding processes typically have relatively smooth surfaces, even when the surfaces are uneven or curved, or have molded textured surfaces with relatively large scale roughness such as peaks and valleys or depressions such as those described above. The durability and quality of printing achieved in accordance with embodiments of the invention may be enhanced if the surface of the cassette print zone has relatively fine grained rough edges. Accordingly, embodiments of the invention include print area conditioner 15 to process or condition the print zone surfaces by scuffing or otherwise applying relatively fine grained rough edges to the smooth or textured print zone surfaces of molded cassettes. The ability of the ink to adhere to and be retained on the cassette when the cassette is subjected to chemical and other environments during processing of histological samples can be increased by the conditioning of the print zone surface. In the embodiment of the invention illustrated in FIG. 1, the print area conditioner 15 includes a motor driven abrasive wheel 18 having a relatively mild abrasive material such as Scotch-Brite™ material from 3M. Other embodiments of the invention (not shown) have other structures and methods for conditioning the surface of the cassette print zone. For example, other abrasive materials and drive mechanisms or chemical etching approaches can be used.

By way of example, a sample print zone surface of smooth high gloss finish molded acetal material (a material commonly used to form tissue cassettes) was determined to have surface variations of about 1.1 μm. The sample surface was scuffed using a ScotchBrite Nylon Mesh Abrasive Pad, Very Fine Grit, and determined to have relatively shallow, fine grained rough edges characterized by surface variations of about 8.4 μm across the grain. The fine grained rough edges of this sample were in the 7-8 μm range. The surface of the conditioned test sample was printed using the method described above, and was tested and determined to provide good print quality and durability that were materially and substantially enhanced over the quality and durability of printing on the same but un-conditioned material. Fine grain rough edges of other dimensional ranges have also been determined to provide material and substantial enhancement to the durability and quality of the printing. For example, the print zone surface of a commercially available molded tissue cassette was determined to have textured surface variations of about 55 μm. The surface of this cassette was conditioned using a ScotchBrite Nylon Mesh Abrasive Pad, Very Fine Grit, and subsequently determined to have surface variations of about 33 μm across the grain. The surface of the conditioned cassette was printed using the method described above, and was tested and determined to provide good print durability and quality that were materially and substantially enhanced over the durability and quality of printing on a similar but un-conditioned cassette. The difference in height between the peaks and valleys in this sample were reduced, but the fine grained rough edges imparted by the conditioning materially and substantially enhanced the durability and quality of the printing. Similar tests with more coarse (e.g., medium grit) ScotchBrite pads produced lesser, but still materially and substantially enhanced durability and quality results.

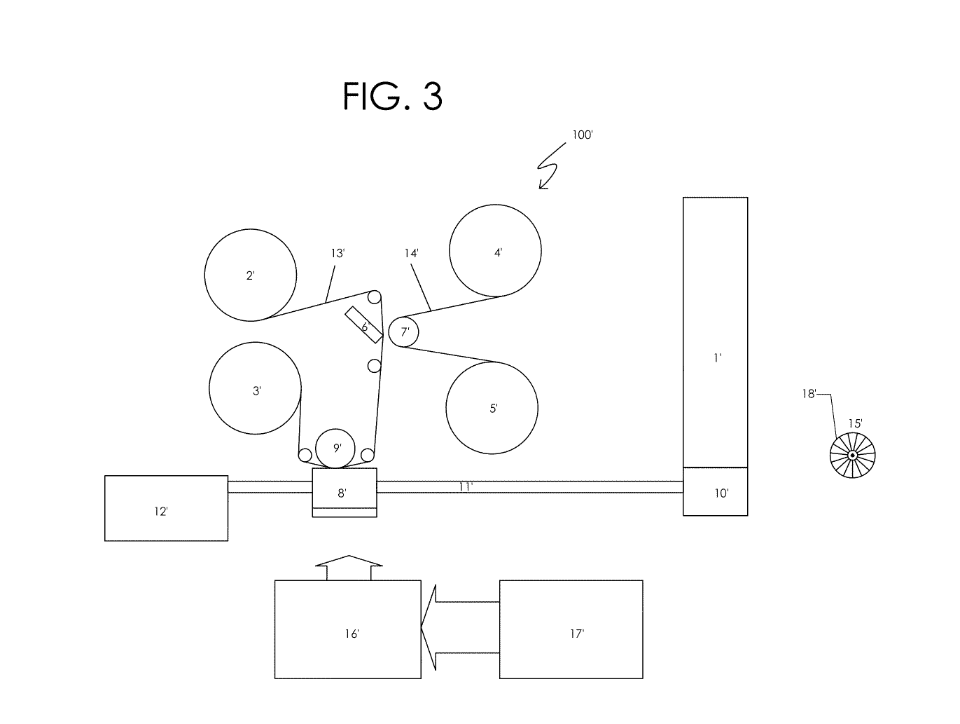

FIG. 3 is an illustration of a histological cassette printer 100′ in accordance with another embodiment of the invention. Printer 100′ does not include a print area conditioner, but is otherwise the same as or similar to printer 100, and similar numbers are used to identify similar features. As shown, a print area conditioner 15′ is located separate from and as a stand-alone component with respect to printer 100′. Print area conditioner 15′ can be the same as or similar to print area conditioner 15, and is used to pre-condition the surface of print zones on cassettes before the cassettes are loaded into the input area 1′. Still other embodiments of the invention (not shown) do not have a print area conditioner.

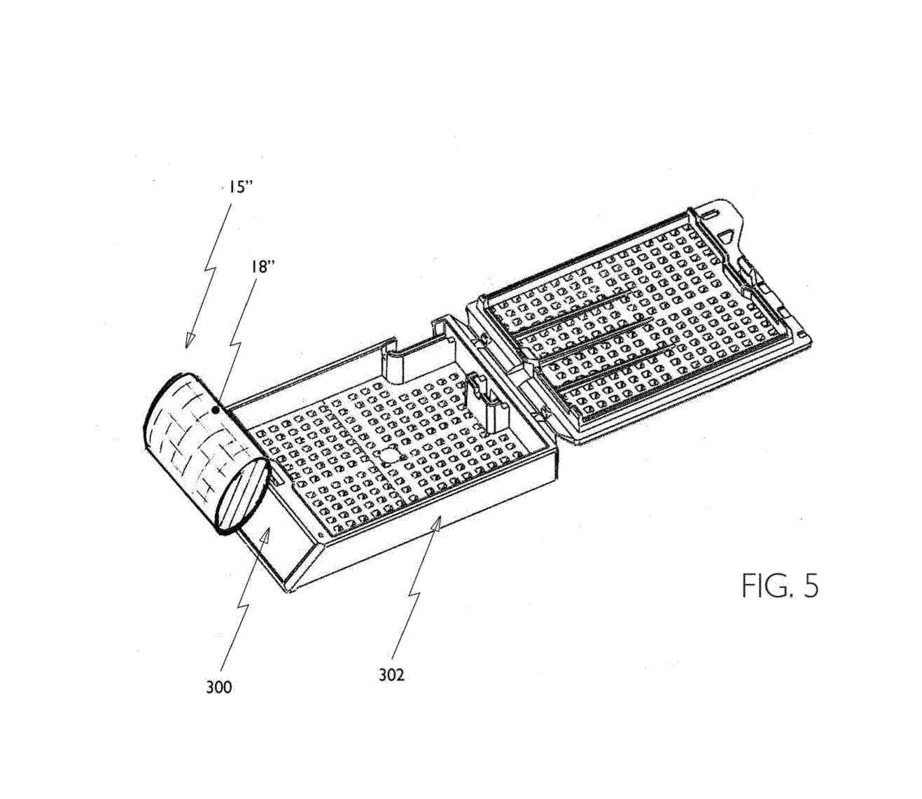

FIG. 5 is a diagrammatic illustration of a cassette print zone conditioner and conditioning method in accordance with another embodiment of the invention. As shown, the print zone 300 of cassette 302 is engaged with an abrasive wheel 18″ of a print area conditioner 15″ for purposes of conditioning the surface of the print zone. Conditioning the print zone 300 enhances the ability of the print zone to durably accept and retain the printed specimen information image as described above. Print area conditioner 15″ can be the same as or similar to the print zone conditioner 15 described above. In other embodiments of the invention, other approaches such as chemical etching or flowing (e.g., sprayed) abrasive material are used to condition the print zone 300 of the cassette 302.

In yet other alternative embodiments the print zone of the cassette, and optionally other surfaces of the cassette, can be molded with a surface that is textured and has fine grained rough edges of the type described above to durably accept and retain the printed specimen information image. The surface of the print zones 300 of cassettes 302 manufactured in accordance with these embodiments of the invention can have a textured surface that is different than other surfaces of the cassette. Cassettes 302 can be pre-conditioned during or after manufacture in accordance with these embodiments of the invention specifically for use in connection with printers such as those described above that do not have an associated print area conditioner, and distributed for use in connection with printers of these and other types.

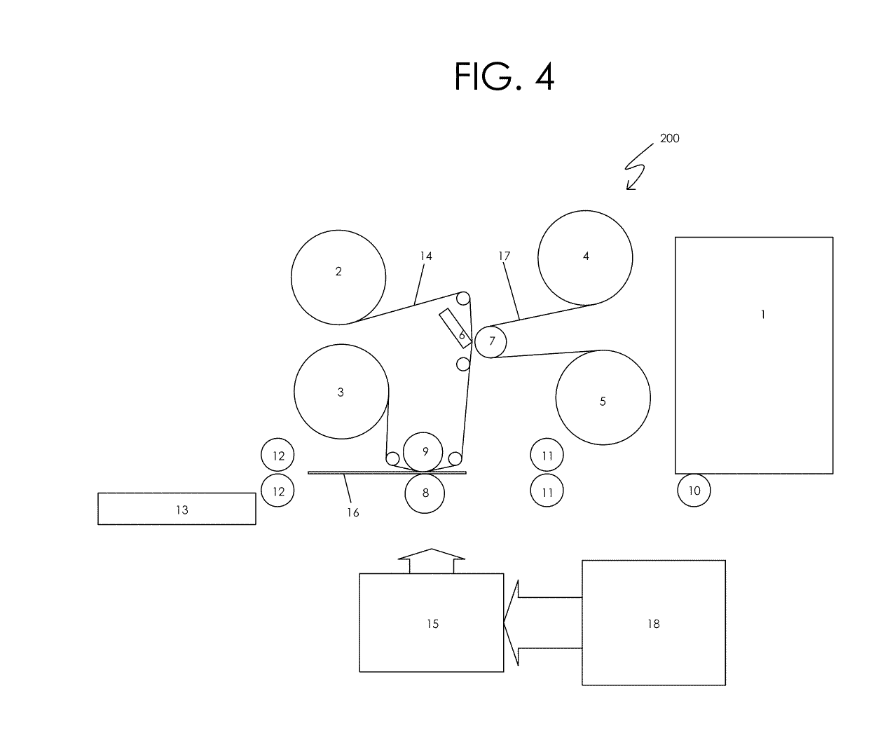

FIG. 4 is an illustration of a histological slide printer 200 in accordance with another embodiment of the invention. Printer 200 prints specimen information onto the print zones of histological slides 16 such as those described above. As shown in FIG. 4, the slides 16 can be loaded into the printer 200 at an input area 1. Slides 16 are removed from the input area 1 by in-feed roller 10 and driven by transfer rollers 11 to a lamination or print transfer area including lamination platen 8 and lamination hot roller 9. Output transfer rollers 12 drive the printed slide 16 from the lamination or print transfer area to the output area 13. Other than these differences, printer 200 can include features and operate in a manner similar to or substantially the same as that of printer 100 described above. In particular, specimen information images are effectively printed in the desired form and color(s) onto the print ribbon 14 (i.e., the negative images are printed off of the print ribbon) during print cycles at the printing region or area including printhead 6 and print platen roller 7. The printed specimen information images are transferred or laminated onto the print zones of the slides 16 at the lamination or print transfer area during lamination cycles.

Although the invention has been described with reference to preferred embodiments, those skilled in the art will recognize that changes can be made in form and detail without departing from the spirit and scope of the invention. Input areas, transfer mechanisms (e.g., including the shuttle and rollers) output areas and other components of printers 100, 100′ and 200 can, for example, be structures similar to or substantially the same as those in the above-identified PCT publications that provide corresponding functions. The printer and method can also be used to print information onto articles other that histological specimen containers.

1. A printer for printing information onto histological specimen containers, such as slides and cassettes, having print zones, including:
an ink receiving structure to receive an ink source;
a collection receiving structure to receive a collection medium;
a printing area including a printhead;
a laminator; and
a control system responsive to specimen data representative of histological specimens to cause the printhead to transfer first color and first format specimen information images away from the ink source and onto the collection medium to form first color and second format specimen images on the ink source, and to cause the laminator to transfer the second format specimen images from the ink source to the print zones of the specimen containers.

2. The specimen container printer of claim 1 wherein:
the ink receiving structure receives a multi-colored ink source; and
the control system causes the printhead to transfer second and optionally additional color first format specimen information images away from the ink source and onto the collection medium to form second color and optionally additional color second format specimen images on the ink source, and causes the laminator to transfer the second and optionally additional color second format specimen images from the ink source to the print zones of the specimen containers.

3. The specimen container printer of claim 2 wherein the printing area and laminator are physically spaced apart and the control system causes sequential printing and laminating operations.

4. The specimen container printer of claim 2 wherein the control system causes more than one sequential printing operation followed by more than one sequential laminating operation.

5. The specimen container printer of claim 2 wherein each color of ink is printed and laminated separately.

6. The specimen container printer of claim 1 wherein:
the ink receiving structure receives a multi-colored ink source, and
the control system causes additional printing and laminating operations with second and optionally additional colors of ink to print color specimen information images on the containers.

7. The specimen container printer of claim 1 and further including a print zone conditioner to condition the print zone of the cassette and materially enhance the durability of printing with respect to printing on a similar but un-conditioned print zone.

8. The specimen container printer of claim 7 wherein the print zone conditioner includes an abrasive for mechanically imparting fine grained rough edges to the surface of the print zone.

9. The specimen container printer of claim 7 wherein the print zone conditioner is part of the printer.

10. The specimen container printer of claim 7 wherein the print zone conditioner is a standalone unit.

11. The specimen container printer of claim 1 wherein the laminator includes a rubber-like roller.

12. The specimen container printer of claim 11 wherein the roller is a heated roller.

13. A printer for printing information onto articles having a print zone, including:
an ink receiving structure to receive an ink source;
a collection receiving structure to receive a collection medium;
a printing area including a printhead;
a laminator; and
a control system responsive to print data to cause the printhead to transfer first color and first format images, such as negative images, away from the ink source and onto the collection medium to form first color and second format images, such as positive images, on the ink source, and to cause the laminator to transfer the second format images from the ink source to the print zones of the articles.

14. The printer of claim 13 wherein:
the ink receiving structure receives a multi-colored ink source; and
the control system causes the printhead to transfer second and optionally additional color first format images away from the ink source and onto the collection medium to form second color and optionally additional color second format images on the ink source, and causes the laminator to transfer the second and optionally additional color second format images from the ink source to the print zones of the articles.

15. The printer of claim 14 wherein the printing area and laminator are physically spaced apart and the control system causes sequential printing and laminating operations.

16. The printer of claim 15 wherein the control system causes more than one sequential printing operation followed by more than one sequential laminating operation.

17. The printer of claim 14 wherein each color of ink is printed and laminated separately.

18. The printer of claim 13 wherein:
the ink receiving structure receives a multi-colored ink source, and
the control system causes additional printing and laminating operations with second and optionally additional colors of ink to print color images on the articles.

19. The printer of claim 13 and further including a print zone conditioner.

20. The printer of claim 19 wherein the print zone conditioner includes an abrasive for mechanically conditioning a surface of the print zone.

21. The printer of claim 19 wherein the print zone conditioner is part of the printer.

22. The printer of claim 19 wherein the print zone conditioner is a standalone unit.

23. The printer of claim 13 wherein the laminator includes a rubber-like roller.

24. The printer of claim 23 wherein the roller is a heated roller.

25. A method for printing information onto an article having a print zone, including:
transferring a first color and first format image away from an ink source and onto a collection medium to form a first color and second format image on the ink source; and
transferring the second format image from the ink source to the print zone of the article.

26. The method of claim 25 and further including:
transferring second and optionally additional color first format images away from the ink source and onto the collection medium to form second color and optionally additional color second format images on the ink source; and
transferring the second and optionally additional color second format images from the ink source to the print zone of the article.

27. The method of claim 26 and further including:
sequentially transferring a plurality of first format images away from the ink source to form a plurality of second format images on the ink source; and
sequentially transferring the plurality of second format images from the ink source to the print zone of the article.

28. The method of claim 25 and further including moving the ink source between the step of transferring the first color and first format image away from the ink source and the step of transferring the second format image to the article.

29. The method of claim 25 and further including conditioning the print zone of the article before printing.

30. The method of claim 29 wherein conditioning the print zone includes abrasively conditioning a surface of the print zone.

31. The method of claim 25 wherein transferring the second format image includes engaging the ink source with a rubber-like roller.

32. The method of claim 31 wherein engaging the ink source with a rubber-like roller includes engaging the ink source with a heated roller.
